(19) United States
(12) Patent Application Publication
(10) Pub. No.: US 2025/0244074 A1
(43) Pub. Date: Jul. 31, 2025

(54) TEMPERATURE REGULATING FEATURES FOR A REFRIGERATOR ICEBOX

(71) Applicant: Haier US Appliance Solutions, Inc., Wilmington, DE (US)

(72) Inventor: Vineeth Vijayan, Louisville, KY (US)

(21) Appl. No.: 18/422,709

(22) Filed: Jan. 25, 2024

(51) Int. Cl. F25D 31/00; F25C 1/04; F25D 27/00; H05B 6/10

(52) U.S. Cl. CPC F25D 31/005; F25C 1/04; F25C 2400/10; F25D 27/00; H05B 6/105

(57) ABSTRACT

A refrigerator appliance includes a cabinet defining a chilled chamber, a heat source mounted to the cabinet, and a door being rotatably mounted to the cabinet to provide selective access to the chilled chamber, the door at least defining an icebox and an access port, the access port being aligned with the heat source when the door is in a closed position.

### FIELD OF THE INVENTION

The present subject matter relates generally to refrigerator appliances, and more particularly to door-mounted icemakers for refrigerator appliances.

### BACKGROUND OF THE INVENTION

Refrigerator appliances generally include a cabinet that defines one or more chilled chambers for receipt of food articles for storage. Typically, one or more doors are rotatably hinged to the cabinet to permit selective access to food items stored in the chilled chamber. Further, refrigerator appliances commonly include ice making assemblies mounted within an icebox on one of the doors or in a freezer compartment. The ice is stored in a storage bin and is accessible from within the freezer chamber or may be discharged through a dispenser recess defined on a front of the refrigerator door.

It may be desirable to place craft icemakers on the freezer door for forming craft ice cubes, which are typically large cubes made by a conventional twist tray icemaker. Ideally, such an icemaker reliably produces high quality ice if the ambient temperature is maintained at a temperature elevated relative to the typical freezer compartment in which the icebox is located. Maintaining temperatures above this level may produce high-quality cubes with no cracks or surface bumps. In addition, these cubes may be easy to release from the icemaker mold. However, due to their positioning within the freezer compartment, door-mounted craft icemakers are typically maintained at too low a temperature, resulting in poor ice quality, poor harvest reliability, and consumer dissatisfaction.

Accordingly, a refrigerator appliance with features for improved ice making would be desirable. More particularly, a refrigerator appliance with a door-mounted craft icemaker that is maintained at a temperature to produce high quality craft ice would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance defining a vertical direction, a lateral direction, and a transverse direction is provided including a cabinet defining a chilled chamber, a heat source mounted to the cabinet, and a door being rotatably mounted to the cabinet to provide selective access to the chilled chamber, the door at least defining an icebox and an access port, the access port being aligned with the heat source when the door is in a closed position.

In another exemplary embodiment, a refrigerator appliance defining a vertical direction, a lateral direction, and a transverse direction including a cabinet defining a chilled chamber, an induction coil mounted to the cabinet, a door being rotatably mounted to the cabinet to provide selective access to the chilled chamber, the door at least partially defining an icebox, and an induction heater mounted within the icebox, the induction heater being aligned with the induction coil when the door is in a closed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1, with the doors of the fresh food chamber and freezer chamber shown in an open position.

FIG. 3 provides a perspective view of an icebox and heat source for use with the exemplary refrigerator appliance of FIG. 1 according to an exemplary embodiment of the present subject matter.

FIG. 4 provides a schematic view of an icebox and heat source for use with the exemplary refrigerator appliance of FIG. 1 according to an exemplary embodiment of the present subject matter.

FIG. 5 provides a schematic view of an icebox and heat source for use with the exemplary refrigerator appliance of FIG. 1 according to an exemplary embodiment of the present subject matter.

FIG. 6 provides a schematic view of an icebox and heat source for use with the exemplary refrigerator appliance of FIG. 1 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

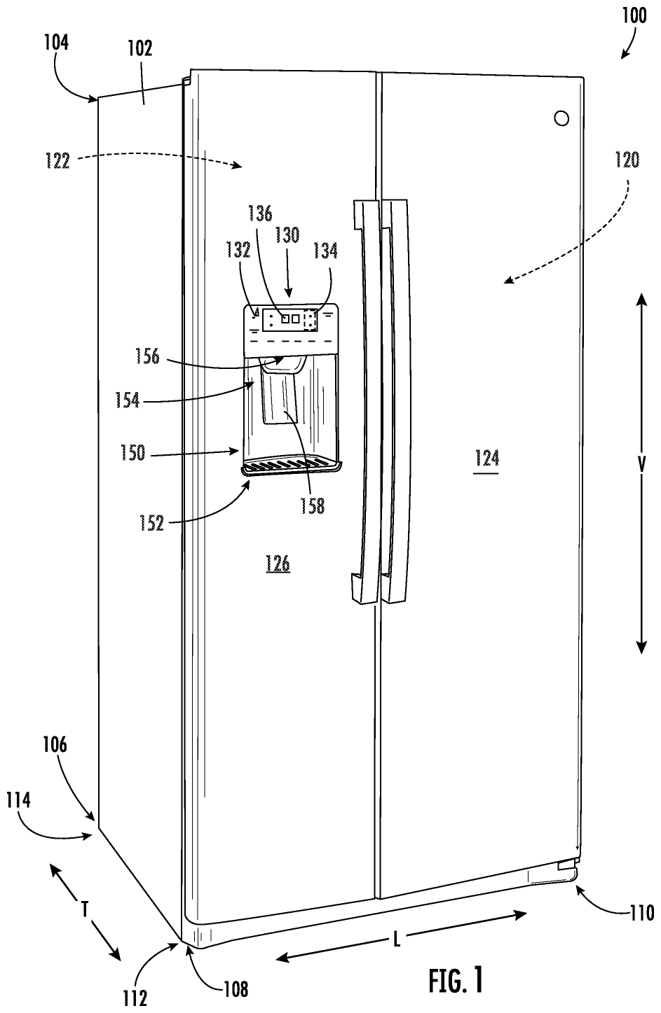

FIG. 1 provides a perspective view of a refrigerator appliance 100 according to an exemplary embodiment of the present subject matter. Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Housing 102 defines chilled chambers for receipt of food items for storage. In particular, housing 102 defines fresh food chamber 120 positioned at or adjacent second side 110 of housing 102 and a freezer chamber 122 arranged at or adjacent first side 108 of housing 102. As such, refrigerator appliance 100 is generally referred to as a side-by-side refrigerator. It is recognized, however, that the benefits of the present disclosure apply to other types and styles of refrigerator appliances such as, e.g., a top mount refrigerator appliance, a bottom mount refrigerator appliance, or a single door refrigerator appliance. Consequently, the description set forth herein is for illustrative purposes only and is not intended to be limiting in any aspect to any particular refrigerator chamber configuration.

A refrigerator door 124 is rotatably hinged to an edge of housing 102 for selectively accessing fresh food chamber 120. In addition, a freezer door 126 is rotatably hinged to an edge of housing 102 for selectively accessing freezer chamber 122. Refrigerator door 124 and freezer door 126 are shown in the closed configuration in FIG. 1. One skilled in the art will appreciate that other chamber and door configurations are possible and within the scope of the present invention.

A control panel 130 is provided for controlling the mode of operation. For example, control panel 130 includes one or more selector inputs 132, such as knobs, buttons, touchscreen interfaces, etc., such as a water dispensing button and an ice-dispensing button, for selecting a desired mode of operation such as crushed or non-crushed ice. In addition, inputs 132 may be used to specify a fill volume or method of operating dispensing assembly 150. In this regard, inputs 132 may be in communication with a processing device or controller 134. Signals generated in controller 134 operate refrigerator appliance 100 and dispensing assembly 150 in response to selector inputs 132. Additionally, a display 136, such as an indicator light or a screen, may be provided on control panel 130. Display 136 may be in communication with controller 134 and may display information in response to signals from controller 134.

As used herein, “processing device” or “controller” may refer to one or more microprocessors or semiconductor devices and is not restricted necessarily to a single element. The processing device can be programmed to operate refrigerator appliance 100 and dispensing assembly 150. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

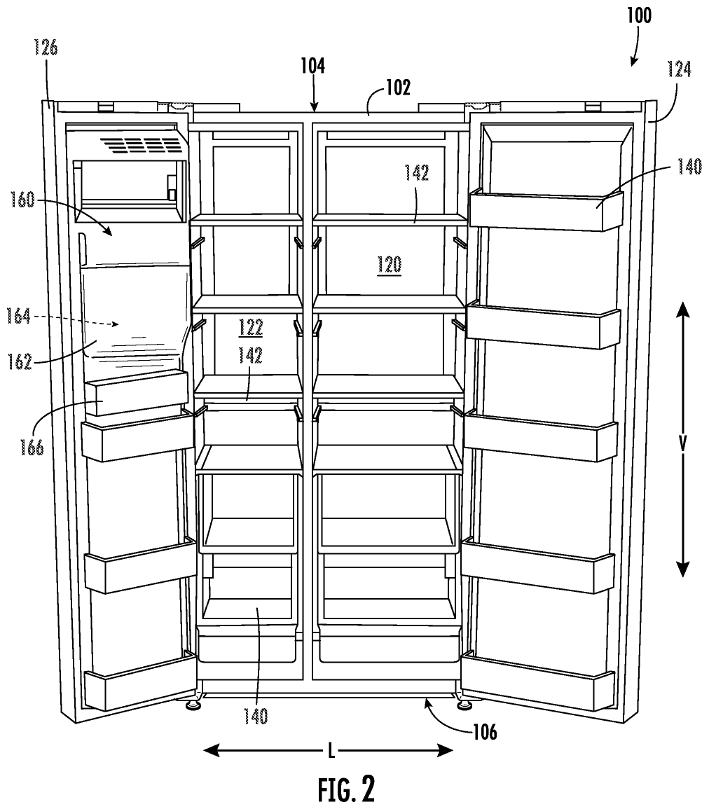

FIG. 2 provides a perspective view of refrigerator appliance 100 shown with refrigerator door 124 and freezer door 126 in the open position. As shown in FIG. 2, various storage components are mounted within fresh food chamber 120 to facilitate storage of food items therein as will be understood by those skilled in the art. In particular, the storage components may include bins 140 and shelves 142. Each of these storage components are configured for receipt of food items (e.g., beverages and/or solid food items) and may assist with organizing such food items. As illustrated, bins 140 may be mounted on refrigerator door 124 and freezer door 126 or may slide into a receiving space in fresh food chamber 120 or freezer chamber 122. It should be appreciated that the illustrated storage components are used only for the purpose of explanation and that other storage components may be used and may have different sizes, shapes, and configurations.

Referring now generally to FIGS. 1 and 2, a dispensing assembly 150 will be described according to exemplary embodiments of the present subject matter. Dispensing assembly 150 is generally configured for dispensing liquid water and/or ice. Although an exemplary dispensing assembly 150 is illustrated and described herein, it should be appreciated that variations and modifications may be made to dispensing assembly 150 while remaining within the present subject matter.

Dispensing assembly 150 and its various components may be positioned at least in part within a dispenser recess 152 defined on freezer door 126. In this regard, dispenser recess 152 is defined on a front side 112 of refrigerator appliance 100 such that a user may operate dispensing assembly 150 without opening freezer door 126. In addition, dispenser recess 152 is positioned at a predetermined elevation convenient for a user to access ice and enabling the user to access ice without the need to bend-over. In the exemplary embodiment, dispenser recess 152 is positioned at a level that approximates the chest level of a user.

Dispensing assembly 150 includes an ice dispenser 154 including a discharging outlet 156 for discharging ice from dispensing assembly 150. An actuating mechanism 158, shown as a paddle, is mounted below discharging outlet 156 for operating ice or water dispenser 154. In alternative exemplary embodiments, any suitable actuating mechanism may be used to operate ice dispenser 154. For example, ice dispenser 154 can include a sensor (such as an ultrasonic sensor) or a button rather than the paddle. Discharging outlet 156 and actuating mechanism 158 are an external part of ice dispenser 154 and are mounted in dispenser recess 152.

As shown in FIG. 2, inside refrigerator appliance 100, freezer door 126 may house one or more icemakers and ice storage bins that are configured forming and storing ice, respectively. In this regard, for example, freezer door 126 may include a first icebox 160 that includes an ice making chamber for housing ice making assemblies, storage mechanisms, and/or dispensing mechanisms. For example, first icebox 160 may be positioned proximate a top of freezer door 126 and may be designed for dispensing standard ice, e.g., through a front of freezer door 126 via dispensing assembly 150.

In addition, according to an example embodiment of the present subject matter, freezer door 126 may also include a second icebox 162 that may house an icemaker 164 that operates independently of the icemaker in first icebox 160. For example, icemaker 164 may be a craft icemaker for forming “craft ice” that is commonly large, clear cubes or spheres of ice for alcoholic or non-alcoholic drinks. A storage bin 166 may be positioned below icemaker for storing formed ice. A user may access this craft ice by opening freezer door 126 and accessing storage bin 166 directly.

Notably, the formation of craft ice may generally be improved if the ice formation temperature is elevated relative to conventional freezer temperatures. For example, conventional freezer temperatures hover around 0° F., whereas desired temperature for forming craft ice of high quality may be between about 15° F. and 20° F. Accordingly, aspects of the present subject matter generally directed to features of icemaker 164 and second icebox 162 that facilitate increased icebox temperatures and improved ice formation.

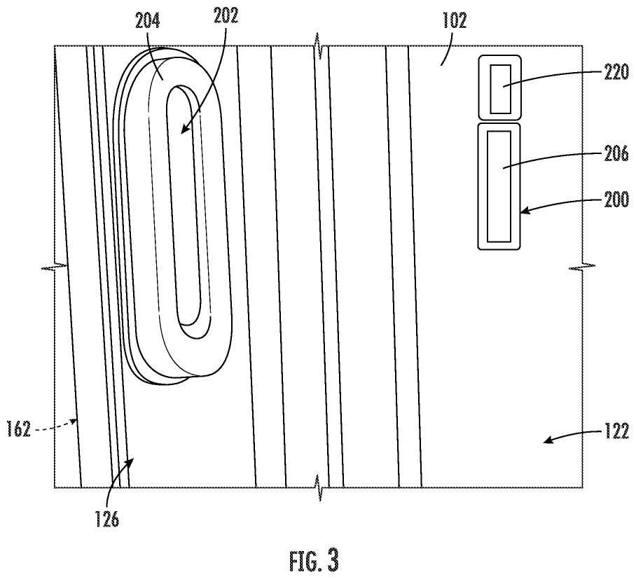

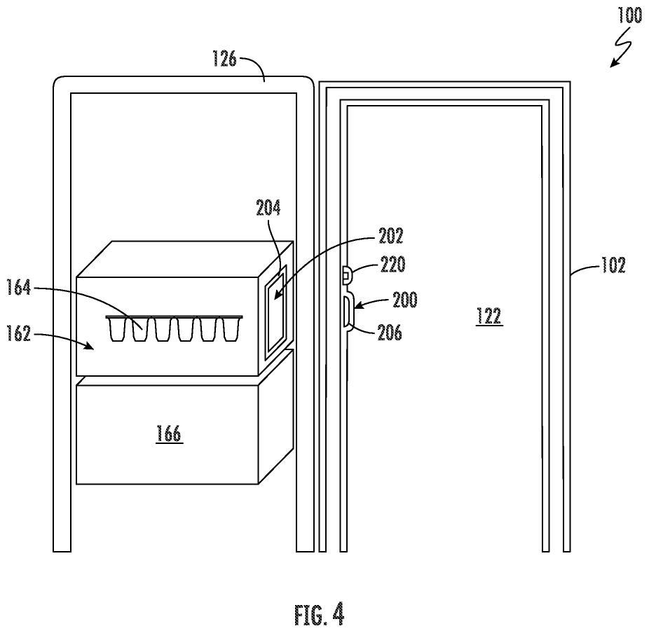

Specifically, referring now also to FIGS. 3 and 4, second icebox 162 may generally be positioned on or defined by freezer door 126. Aspects of the present subject matter are generally directed to methods for maintaining second icebox 162 within a desirable temperature range for producing high quality craft ice. For example, according to the illustrated embodiment, refrigerator appliance 100 may include a heat source 200 that is mounted to cabinet 102 and is thermally coupled to the second icebox 162 when freezer door 126 is in the closed position. For example, heat source 200 may be mounted on cabinet 102 at a location adjacent to or abutting against freezer door 126 when freezer door 126 is in the closed position. As described in more detail below, heat source 200 may be selectively operated to provide heat to second icebox 162 and maintain a desirable temperature therein.

According to the illustrated embodiment, freezer door 126 may define an access port 202 that is aligned with heat source 200 when freezer door 126 is in the closed position. In this regard, access port 202 may be an opening defined through an inner door panel of freezer door 126 that opens directly into second icebox 162. Notably, mounting heat source 200 on cabinet 102 for providing heat into second icebox 162 may facilitate temperature regulation within second icebox 162 without requiring wiring that passes through a hinge of freezer door 126, thereby reducing costs and improving reliability. Referring specifically to FIG. 3, refrigerator appliance 100 may further include a gasket 204 that is positioned around access port 202 and forms a seal with cabinet 102 when freezer door 126 is in the closed position. In this regard, gasket 204 may surround the perimeter of access port 202 and may encircle heat source 200 when freezer door 126 is in the closed position.

It should be appreciated that heat source 200 may be any suitable device that produces thermal energy that may be transferred into second icebox 162. For example, the source 200 may be a resistive heater that is selectively energized to produce heat. According to still other embodiments, heat source 200 may be a light source that is energized to produce light and generate heat. For example, as illustrated in FIG. 3, heat source 200 may be an array of light emitting diodes 206 that are selectively energized to heat second icebox 162. Notably, light emitting diodes 206 may also be used to illuminate freezer chamber 122 when freezer door 126 is in the open position.

Referring now specifically to FIG. 5, according to alternative embodiments, heat source 200 may include an induction coil 210 that is mounted within cabinet 102 adjacent freezer door 126. In addition, refrigerator appliance 200 may include a heating plate 212 that is positioned within second icebox 162. According to example embodiments, operating induction coil 210 when freezer door 126 is in the closed position may cause heating plate 212 to heat up and provide thermal energy into second icebox 162. Notably, it should be appreciated that the use of induction coil 210 and heating plate 212 may eliminate the need for access port 202. Example, heating plate 212 may cover-up access port 202 or access port 202 may be omitted altogether. In addition, induction coil 210 and/or heating plate 212 may be embedded within cabinet 102 and and/or freezer door 126, respectively, e.g., such that they are not visible to a user of refrigerator appliance 100.

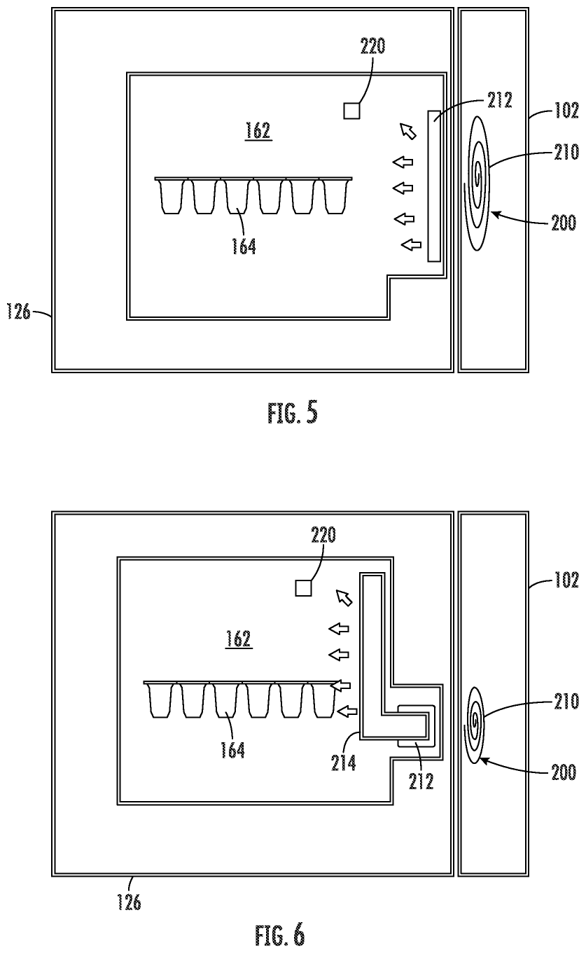

As shown in FIG. 6, refrigerator appliance 100 may further include a heat pipe 214 that is positioned within second icebox 162 for transmitting heat throughout second icebox 162. In this regard, heat pipe 214 may be thermally coupled to heating plate 212 or may be formed from a material that may be heated using induction coil 210. Accordingly, by operating induction coil 210, heat pipe 214 may operate to generate and/or transmit heat throughout second icebox 162. It should be appreciated that the size, shape, and configuration of heating plate 212 and/or heat pipe 214 may vary while remaining within the scope of the present subject matter. In addition, it should be appreciated that according to such embodiments, temperature sensor 220 may be positioned within second icebox 162.

According to an example embodiment of the present subject matter, access port 202 may be covered by a transparent window (not labeled). Accordingly, the transparent window may prevent cool air from exiting second icebox 162 when freezer door 126 is in the open position. In addition, when freezer door 126 is in the closed position, transparent window may permit thermal radiation from heat source 200 to pass into and heat second icebox 162.

Refrigerator appliance 100 may further include one or more temperature sensors 220 that are generally positioned for monitoring the temperatures of second icebox 162. Specifically, according to the illustrated embodiment, temperature sensor 220 may be positioned on cabinet 102 adjacent source 200. In this manner, freezer door 126 is in the closed position, temperature sensor 220 may be placed in thermal communication with second icebox 162 for measuring temperatures therein. Similar to heat source 200, placing temperature sensor 220 on cabinet may eliminate the need for passing a wiring harness through a hinge into freezer door 126. Controller 134 may be programmed for facilitating closed loop temperature control of second icebox 162. In this regard, controller 134 may be programmed to obtain icebox temperature using temperature sensor 220 and operate heat source 200 in order to maintain the icebox temperature within a target temperature range.

As used herein, “temperature sensor” or the equivalent is intended to refer to any suitable type of temperature measuring system or device positioned at any suitable location for measuring the desired temperature. Thus, for example, temperature sensor 220 may each be any suitable type of temperature sensor, such as a thermistor, a thermocouple, a resistance temperature detector, a semiconductor-based integrated circuit temperature sensor, etc. In addition, temperature sensor 220 may be positioned at any suitable location and may output a signal, such as a voltage, to a controller that is proportional to and/or indicative of the temperature being measured. Although exemplary positioning of temperature sensors is described herein, it should be appreciated that refrigerator appliance 100 may include any other suitable number, type, and position of temperature, humidity, and/or other sensors according to alternative embodiments.

As explained herein, aspects of the present subject matter are generally directed to a heating system for a craft icemaker installed on a freezer door of a side-by-side refrigerator. The heat source may be freezer lighting which is primarily used for illuminating the freezer compartment. A temperature sensor may be located on the freezer wall and may be used to monitor or control the conditions inside the ice maker chamber when the freezer door is in closed condition. The ice making chamber may include one or more access ports on the wall that will enclose the freezer lighting and a temperature sensor (e.g., a thermistor) when the freezer door is in closed position. The freezer lighting may provide heat for temperature control and could also eliminate or reduce frost formation on one or more surfaces of the icemaker chamber. Instead of the access port being an opening that encloses the heat source when the door is closed, it could be a heat transfer port with the light source remaining outside the icemaker even when the freezer door is closed. Such a port could be a transparent window that will allow thermal radiation from the light to pass through to heat the icemaker chamber.

According to example embodiments, the present subject matter may be directed to a heating system for a craft icemaker installed on the freezer door of side-by-side refrigerator. The heat source may be a combination of an induction power transmission source located on the freezer wall that would couple to a metal receiver on the ice making chamber wall when the freezer door is closed. Inductive heating may happen only when the freezer door is in closed state and the transmitter coil can be in proximity with the metal receiver. At least one temperature sensor (e.g., a thermistor) may be located on the freezer wall for monitoring or controlling the conditions inside the icemaker chamber when the freezer door is in closed condition. The ice maker chamber may have one or more access ports on the wall that will enclose the induction coil location and thermistor when the freezer door is in closed position. Inductive heating may provide heat for temperature control and could also eliminate or reduce frost formation on one or more icemaking chamber surfaces. In an alternate embodiment, instead of the access port being an opening that encloses the heat source when the door is closed, it could be a heat transfer port with thin or no insulation to minimize the distance from the induction coil and the work piece. The work piece could be a metal receiver or a heat pipe which heats up when induction coil is powered.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction, a lateral direction, and a transverse direction, comprising:
a cabinet defining a chilled chamber;
a heat source mounted to the cabinet; and
a door being rotatably mounted to the cabinet to provide selective access to the chilled chamber, the door at least defining an icebox and an access port, the access port being aligned with the heat source when the door is in a closed position.

2. The refrigerator appliance of claim 1, further comprising:
a gasket surrounding access port, the gasket forming a seal with the cabinet when the door is in the closed position.

3. The refrigerator appliance of claim 1, wherein the heat source is a resistive heater.

4. The refrigerator appliance of claim 1, wherein the heat source is light source.

5. The refrigerator appliance of claim 4, wherein the light source is configured to illuminate the chilled chamber when the door is in an open position.

6. The refrigerator appliance of claim 4, wherein the light source is a light emitting diode.

7. The refrigerator appliance of claim 1, wherein the heat source is an induction coil, refrigerator appliance further comprising:
a heating plate positioned within the icebox and being operably coupled with the induction coil when the door is in the closed position.

8. The refrigerator appliance of claim 7, wherein the heating plate is positioned within the access port.

9. The refrigerator appliance of claim 1, further comprising:
a transparent window positioned over the access port, wherein the heat source emits thermal radiation that travels through the transparent window.

10. The refrigerator appliance of claim 1, further comprising:
a temperature sensor positioned in thermal communication with the icebox.

11. The refrigerator appliance of claim 10, wherein the temperature sensor mounted to cabinet adjacent the heat source.

12. The refrigerator appliance of claim 10, further comprising a controller operably coupled to the heat source and the temperature sensor, the controller being configured to:
obtain an icebox temperature using the temperature sensor; and
operate the heat source to maintain the icebox temperature within a target temperature range.

13. The refrigerator appliance of claim 1, wherein the icebox is maintained at a temperature between about 15° and 20° Fahrenheit above a temperature of the chilled chamber.

14. The refrigerator appliance of claim 1, further comprising:
a craft icemaker positioned within the icebox.

15. The refrigerator appliance of claim 1, wherein the chilled chamber is a freezer compartment of the refrigerator appliance.

16. The refrigerator appliance of claim 1, wherein the refrigerator appliance is a side-by-side refrigerator appliance.

17. A refrigerator appliance defining a vertical direction, a lateral direction, and a transverse direction, comprising:
a cabinet defining a chilled chamber;
an induction coil mounted to the cabinet;
a door being rotatably mounted to the cabinet to provide selective access to the chilled chamber, the door at least partially defining an icebox; and
an induction heater mounted within the icebox, the induction heater being aligned with the induction coil when the door is in a closed position.

18. The refrigerator appliance of claim 17, wherein the induction heater is a metal receiver positioned within the icebox.

19. The refrigerator appliance of claim 17, further comprising:
a heat pipe thermally coupled to the induction heater.

20. The refrigerator appliance of claim 17, further comprising:
a temperature sensor positioned in thermal communication with the icebox; and
a controller operably coupled to the induction coil and the temperature sensor, the controller being configured to:
obtain an icebox temperature using the temperature sensor; and
operate the induction coil to maintain the icebox temperature within a target temperature range.
